(19) United States
(12) Patent Application Publication
(10) Pub. No.: US 2025/0129663 A1
(43) Pub. Date: Apr. 24, 2025

(54) HORIZONTAL SYNCHRONIZED BALANCING SYSTEM

(71) Applicant: Huey Ai KUO, Yorba Linda, CA (US)

(72) Inventor: Tser Wen CHOU, Yorba Linda, CA (US)

(21) Appl. No.: 18/492,499

(22) Filed: Oct. 23, 2023

(51) Int. Cl. E06B 9/322; E06B 9/303; E06B 9/323

(52) U.S. Cl. CPC E06B 9/322; E06B 9/303; E06B 9/323; E06B 2009/3222

(57) ABSTRACT

A horizontal synchronized balancing system includes a rail, a spring box disposed in the rail, at least two friction balance point brass rollers and at least two lift cords. A head end of the lift cord is wound on the cord reel of the spring box, while a tail end of the lift cord is conducted out of two sides of the spring box through a lower side of the brass roller of the friction balance point brass roller and then wound on an upper side of the friction balance point brass roller and then conducted downward through a hole in the middle of the tap drum support. By means of the tension support of the cord reel in the spring box and the weight support of the bottom rail and the slats and the synchronization provided by the friction balance point brass rollers, the bottom rail and the slats are always kept in balancing position and balancing weight. Therefore, when the bottom rail is manually moved to any height.

### BACKGROUND OF THE INVENTION

### 1. Field of the Invention

The present invention relates generally to a horizontal synchronized balancing system, and more particularly a balancing system in which the slats and bottom rail may be manually moved, ascending or descending, to any position with less physical effort.

### 2. Description of the Related Art

A horizontal blind is structurally designed with a tilter and pull cord lock installed in a U-shaped blind rail. This requires that at least two tape drum support brackets be installed in the blind rail. Each drum support has a drum to which a ladder is attached that will control and support the blind's horizontal slats. A rectangular rod runs through each of these drums and connects with the wand or cord tilter. Pulling the cord of the cord tilter or rotating the wand tilter will rotate the rod running through the drums thereby rotating the drums forward or backward and likewise the slats. This allows the slats to close in the up or down position for privacy and various amounts of shade or open for light and view in the opened horizontal position.

The blind slats and bottom rail are raised and lowered by pull/lift cords attached to the bottom rail with each running up through the slats, across the blind rail and through a cord lock. The bottom rail and slats are raised or lowered to any position using this pull/lift cord with the cord lock firmly holding the cord and blind in place until released and repositioned.

The conventional pull/lift cord horizontal blind can present a serious hazard to small children when not properly assembled and installed according to industry standards or if not responsibly maintained over the years. In order to eliminate this child safety concern with pull/lift cords, the cordless blind was developed by the window covering industry.

With respect to the operation of the cordless blind, a user controls the blind by raising or lowering the blind's bottom rail. Some systems use a physical lock to hold the bottom rail and slats in position while others fail to match spring box torsion resulting bounce back or downward slippage when released. Such mismatching of spring box torsion with the various lift cords also contributes to the bottom rail and slats rail being askew or uneven when lifted or drawn downward unless done so from the bottom rail center. The operation of such a cordless blind is quite inconvenient and such a blind design is not optimal.

### SUMMARY OF THE INVENTION

It is therefore a primary object of the present invention to provide a horizontal cordless system that is balanced, synchronized and level regardless the number of spring boxes or bottom rail pull or lift position.

Balance is achieved by each spring box lift cord being passed under and then wrapped up and over one or more of the steel rods with a brass roller of the drum supports before it descends through the hole in the horizontal track, through the slats and is attached to the bottom rail. This wrap around the combined brass roller on the steel rod is called the friction balance point brass roller and it allows the tension of the spring box's cord reel and weight of the slats and bottom rail to find balance regardless of position and maintain such without any physical lock.

Each friction balance point of each wrapped lift cord produces a synchronized reaction from each balance point when there is a manual lifting or lowering of the bottom rail. The connecting of all the friction balance point brass rollers lift cords to the bottom rail forms a unified system where all friction balance points repeat the same reaction. This synchronized reaction maintains a level bottom rail regardless of one's hand lifting or lowering position. This is unlike other systems when lifting the bottom rail from either side rather than the center sets it askew as the lift cords act independently of each other. This requires the user to fully lower the slats and bottom rail to reset the cords to level the bottom rail which is burdensome as this process is likely to repeated many times.

When more than a single spring box is required, our method of running each box's cords across the blind rail's length allows both boxes with their assigned friction balance point brass rollers to operate in a single synchronized fashion. The rotating brass rollers on the stationary steel rods allow each friction balance point brass roller to temper the friction and smoothly assist the lifting pull back tension of the spring box when manually lifting the bottom rail. This assistance means the manual lifting requires less strength.

To achieve the above and other objects, the present invention provides a horizontal synchronized balancing system including: a rail having an inward recessed space; at least two friction balance point brass rollers, each of the friction balance point brass rollers including at least one steel rod and at least one brass roller fitted on the steel rod and a tape drum support having two recesses, the ends of the steel rod or rods being secured in the recesses of the tape drum supports without possibility of rotation, a gap being defined between the brass roller and the steel rod fitted in the brass roller, whereby the steel rod only contacts with the brass roller on the top line of the steel rod allowing the brass roller to rotate; at least one spring box including a spring and a cord reel, the cord reel being controlled by the spring and rotatable; and at least two lift cords, a head end of each lift cord being connected on the cord reel of the spring box, while a tail end of the lift cord being conducted under the lower side of the brass roller on the steel rod and then back over the top of the same brass roller and then downward through the hole in the middle of the tape drum support and blind rail and then conducted through a slot in each slat to connect with a bottom rail. Synchronization is achieved by the unity of the friction balance point brass rollers, the tension of the cord reel and the weight of the slats connected to the bottom rail and the friction generated between the lift cords and the rotating balance point brass rollers. Balance and stable positioning are the result. Alternatively, a user can move the bottom rail with a hand to change the balancing weight and balancing position state between the weight of the bottom rail and the slats and the tension of the cord reel to cordlessly control ascending/descending of the bottom rail and the slats in a new balanced state with all remaining level.

With respect to the primary technical core of the present invention, the horizontal synchronized balancing system of the present invention includes a rail, a spring box positioned in the rail, at least two friction balance point brass rollers and at least two lift cords. The spring box has a spring and a cord reel controlled by the spring to wind up the lift cord. Each of the friction balance point brass rollers is composed of a steel rod, brass roller, and a tape drum support. By unifying the tension support of the cord reel in the spring box and its attached lift cords and the weight support of the bottom rail and slats into a single unit by connecting each friction balance point brass roller's lift cord to the bottom rail, the bottom rail and slats are always kept in a synchronized balanced level position. When it is desired to move the bottom rail and slats upward or downward to any position, a user can pull down or lift any portion of the bottom rail with a hand to change the balancing weight and balancing position state between the weight of the bottom rail and the slats and the tension of the spring box cord reel. The cord reel is driven and rotated to control at least two lift cords to synchronously move upward or downward. When the hand stops moving the bottom rail, the bottom rail and slats are established at that new position. By means of the rotation and driving of the friction balance point brass roller, the ascending and descending operation of the slats and bottom rail requires less manual strength.

With respect to the secondary technical core of the horizontal synchronized balancing system of the present invention, in case the tension of the cord reel fails to match the weight of the bottom rail and the slats and cannot be balanced therewith so as to move the bottom rail and slats up or down to reach a desired position, the number of steel rods with brass rollers to form the number of friction balance point brass rollers are increased to increase friction or at least one weight rod is placed into the bottom rail to increase weight so as to enhance the synchronization of the friction balance point brass rollers. Therefore, the tension of the cord reel can match the weight of the bottom rail and the slats to achieve the balancing position and balancing weight to relocate the bottom rail and slats.

The present invention can be best understood through the following description and accompanying drawings, wherein:

### BRIEF DESCRIPTION OF THE DRAWINGS

FIG. 1 is a perspective explode view of the present invention;

FIG. 2 is a perspective view of the balance point brass roller on the left side;

FIG. 3 is a perspective view of the balance point brass roller on the right side;

FIG. 4 is a perspective exploded view of the brass roller and the steel rod of the present invention;

FIG. 5 is a perspective assembled view if the brass roller and the steel rod of the present invention;

FIG. 6 is a perspective view that the horizontal lift cord is wound on the balance point brass roller and its vertical decent; is a perspective view that the horizontal lift cord is wound on the balance point brass roller and its continued horizontal travel;

FIG. 7 is a plane view showing that the lift cord is wound on the friction balance point brass roller that has space to rotate;

FIG. 8 is a front view showing the descending lift cord wound on the brass roller and steel rod within the tape drum support;

FIG. 9 is a perspective assembled view of the horizontal blind of the present invention;

FIG. 10 is a plane assembled view of the horizontal blind of the present invention;

FIG. 11 is a plane assembled view of the horizontal blind of the present invention. In which the slats are pulled downward and increasing the spring box's lift;

FIG. 12 is a plane view showing the forces of the present invention are in balance;

FIG. 13 is a plane view showing movement of the lift cord of the present invention;

FIG. 14 is a perspective view showing the operation of the present invention from center;

FIG. 15 is a perspective view showing the operation of the present invention from a lateral side;

FIG. 16 is a perspective view showing that the slats of the present invention are collected when lifted and stacked on each other;

FIG. 17 is a perspective view showing that the slats are level pulled down from a lateral side;

FIG. 18 is a plane view of an embodiment of the present invention, in which four balance point brass rollers are installed;

FIG. 19 is a plane view of an embodiment of the present invention, in which two lift cords and three friction balance point brass rollers are installed;

FIG. 20 is a plane view of an embodiment of the present invention, in which four lift cords are installed;

FIG. 21 is a perspective view of the balance point brass roller of the present invention on the left side, in which the tape drum support has two friction balance point brass rollers;

FIG. 22 is a perspective view of the balance point brass roller of the present invention on the right side, in which the tape drum support has two friction balance point brass rollers;

FIG. 23 is a top view of the balance point brass roller of the present invention, in which each tape drum support has two balance point brass rollers;

FIG. 24 is a plane view showing the installation of each tape drum support of the present invention with two friction balance point brass rollers; and

FIG. 25 is a plane view showing the application of a mixture of tape drum supports with one and two balancing brass rollers.

### DETAILED DESCRIPTION OF THE PREFERRED EMBODIMENTS

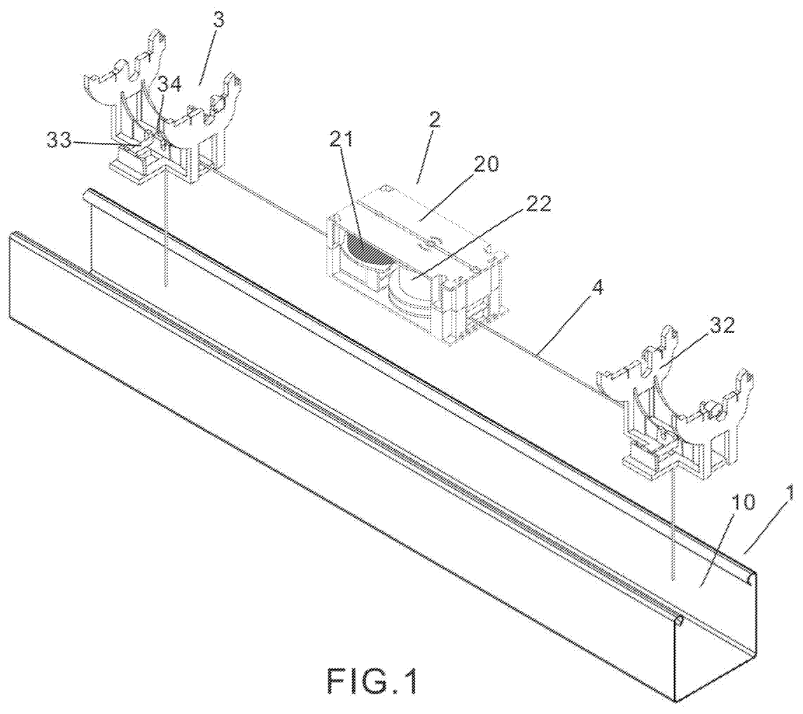

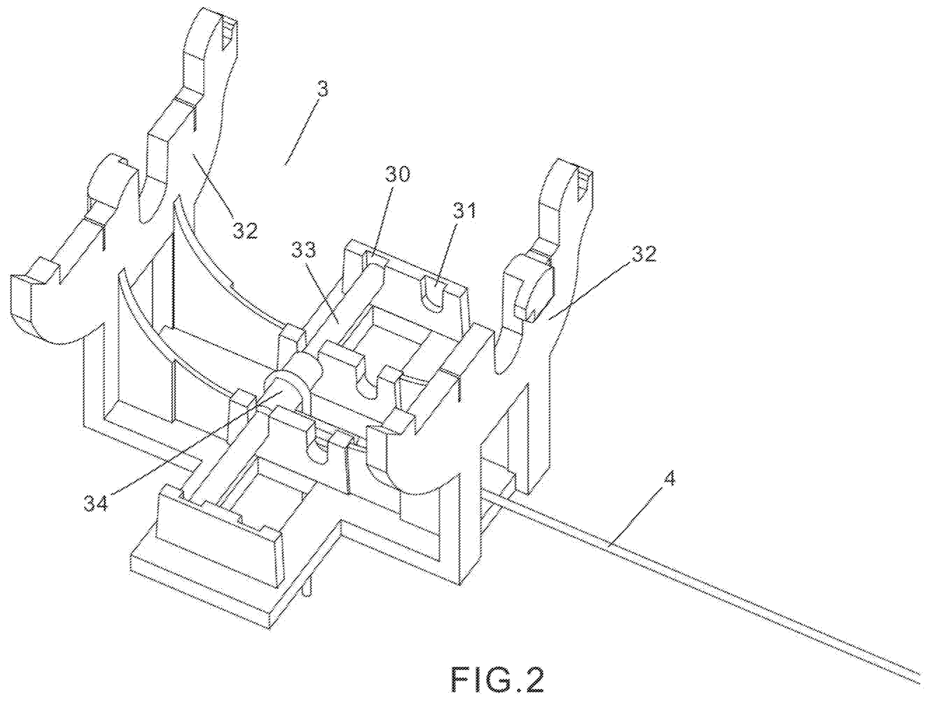

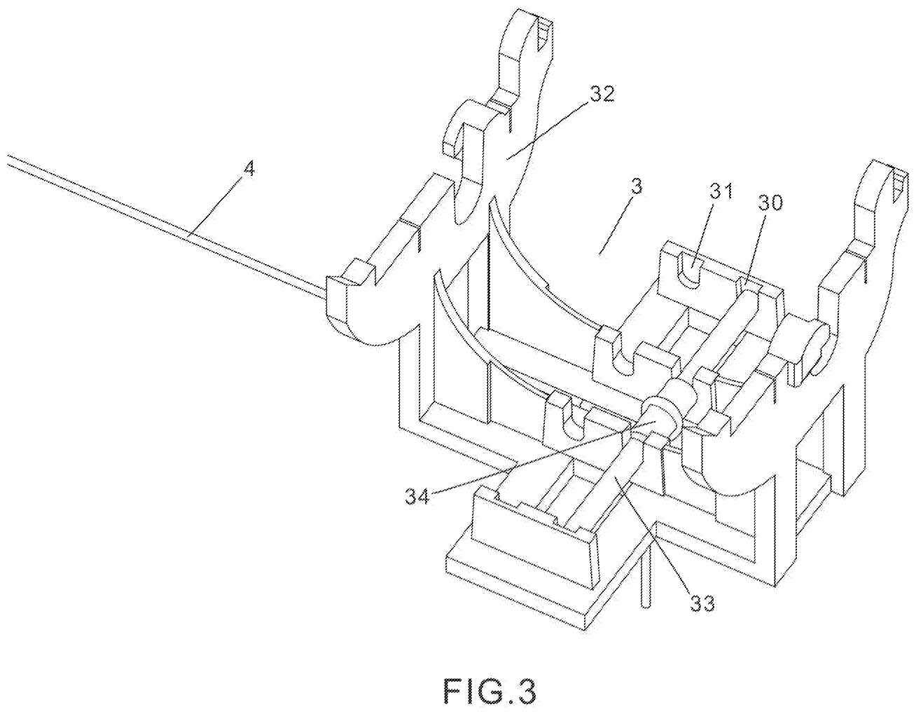

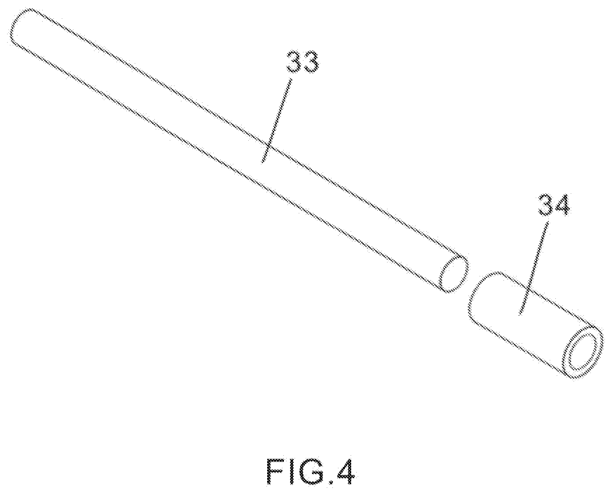

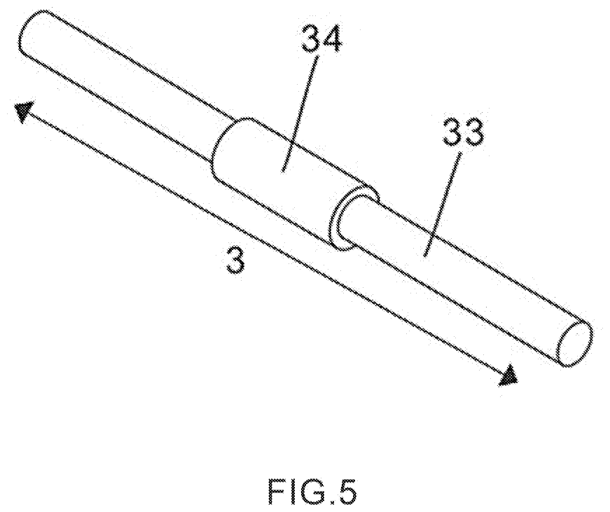

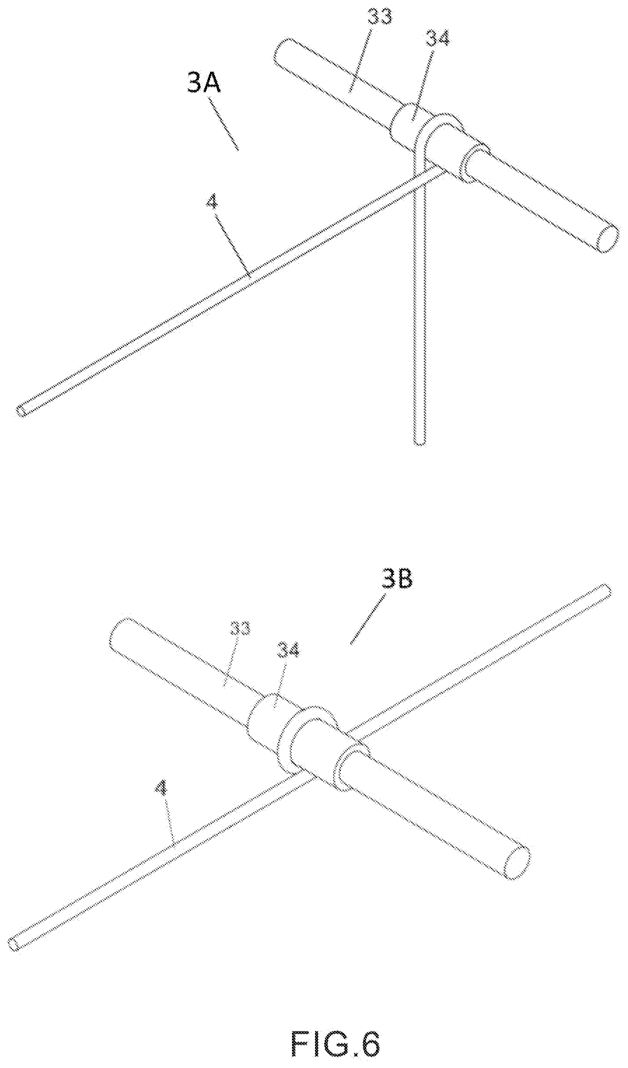

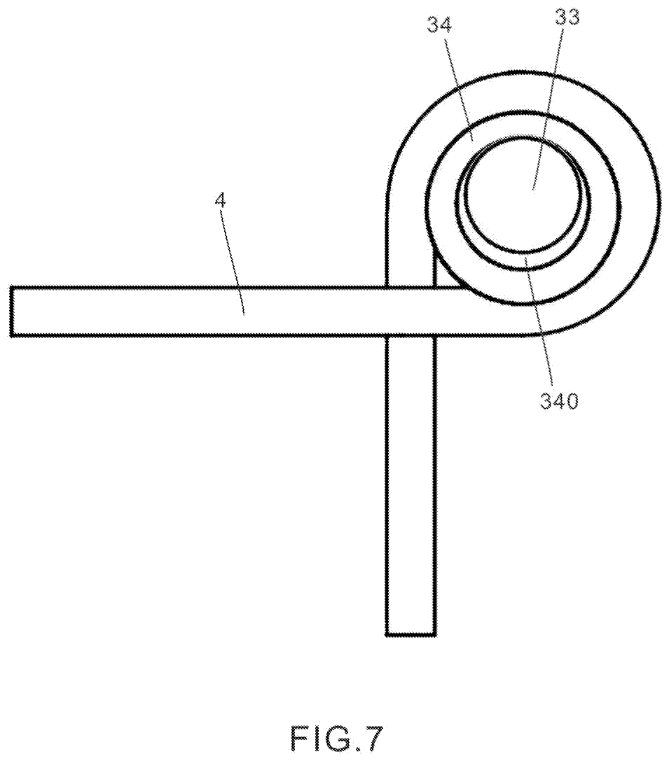

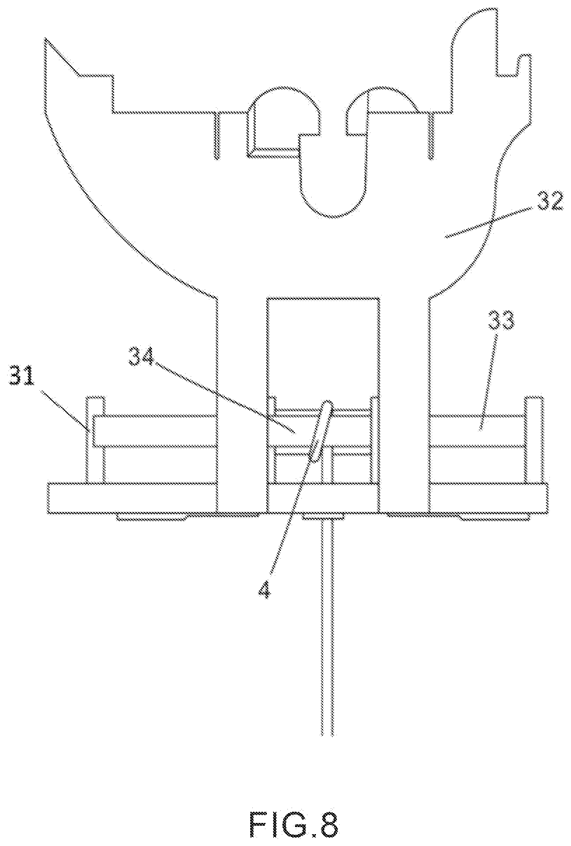

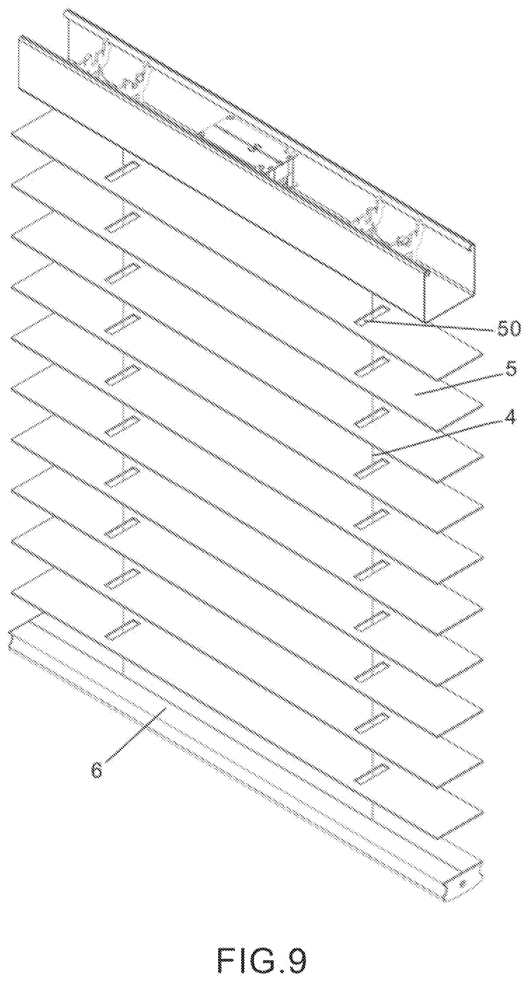

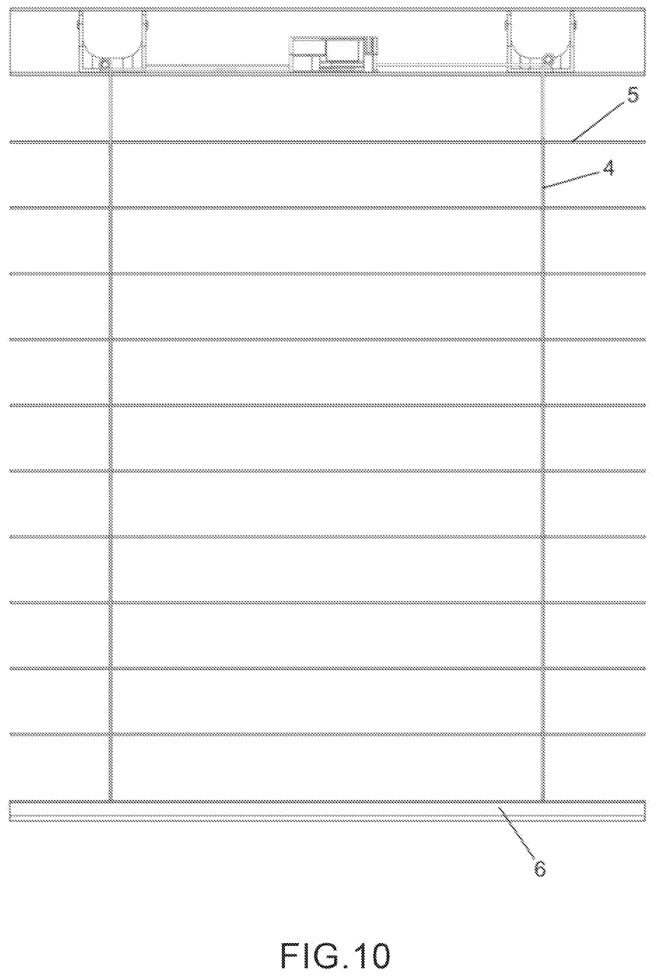

Please refer to FIG. 1. The horizontal synchronized balancing system of the present invention mainly includes a rail 1, a spring box 2 with at least two spring box lift cords 4 and at least two tape drum support 32 each with at least one stationary steel rod 33 with its balancing brass roller 34 forming a friction balance point brass roller 3. The rail 1 has and inward recesses space 10. The spring box 2 has a box main body 20. A coiled spring 21 and a cord reel 22 are respectively disposed on two sides of the box main body 20. The coiled spring 21 and the cord reel 22 are connected with each other, whereby the coiled spring 21 provides an elastic force for driving the cord reel 22 to rotate. The tape drum supports 32 (as shown in FIGS. 2 and 3) are disposed on left and right sides of the inward recessed space 10 of the rail 1. Each tape drum support 32 has two recesses 30, 31 and at least one steel bar 33 and a balancing brass roller 34 fitted together 3 as a friction balance point brass roller (as shown in FIGS. 4 and 5). FIG. 6 shows two of the possible lift cord 4 wraps around the friction balance point brass roller 3, the under, over and down to bottom rail 3A and the under, over, under and continuing 3B towards a 3A. FIG. 7 shows a gap 340 as defined between the balancing brass roller 34 and the steel rod 33, whereby the steel rod 33 only contacts the balancing brass roller 34 by a straight line. FIG. 8 shows the steel rod 33 portion of the balance point brass roller 3 is securely placed in the tape drum support 32 recess 31 on the outer side without possibility of rotation, while the balancing brass roller 34 is freely rotatable around the steel rod 33. An outer circumferential surface of the balancing brass roller 34 is a polished face. A head end of the spring box lift cord 4 is connected on the cord reel 22 of the spring box 2, while a tail end of the lift cord 4 is conducted out of the box main body 20 of the spring box 2 through a lower side of the friction balancing brass roller 34 then up and back over the upper side of the friction balancing brass roller 34 and the conducted through an opening at the bottom of the tape drum support 32. Thereafter, the tail end of the lift cord 4 is downward conducted through a slot 50 of the slat 5 to connect with the bottom rail 6. After the above components are assembled, two lift cords 4 are used to synchronously control ascending or descending of the bottom rail 6 and the slats 5 (as shown in FIGS. 9 and 10).

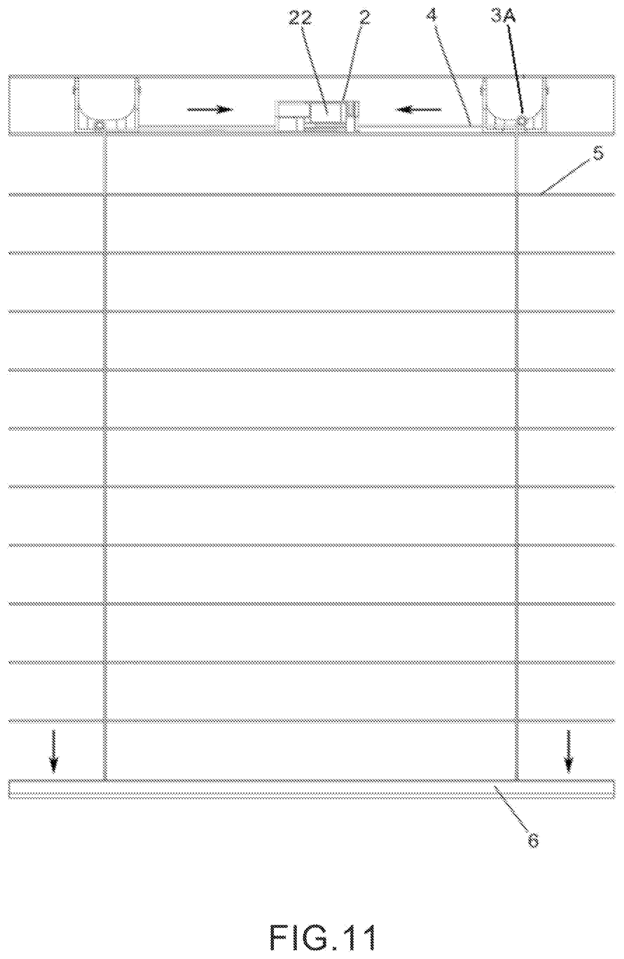

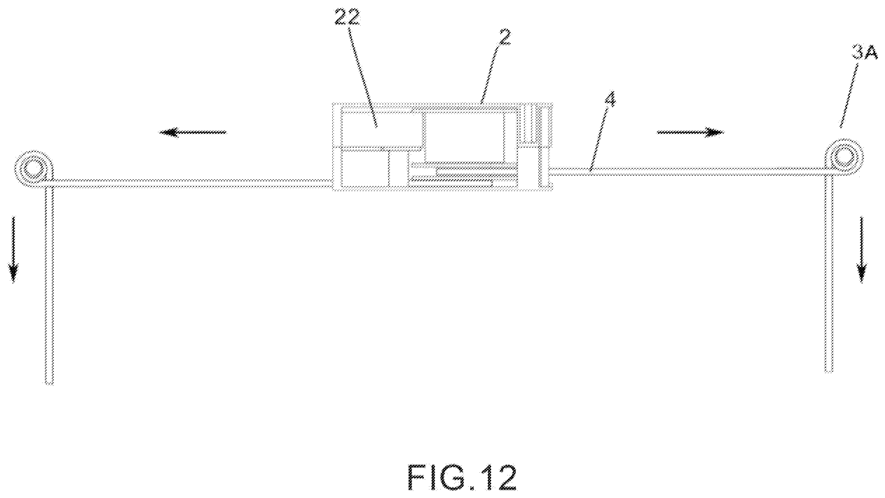

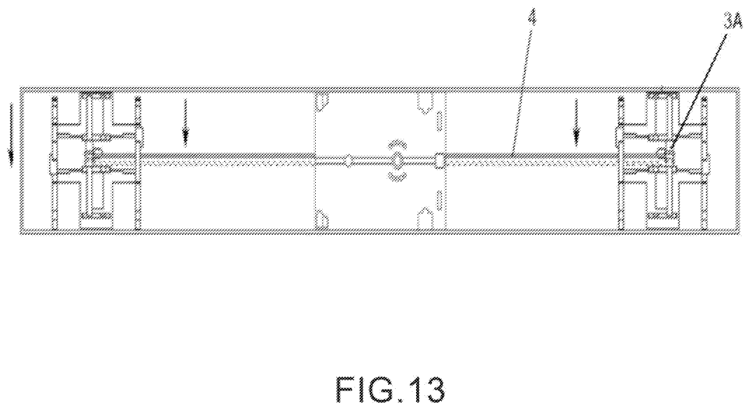

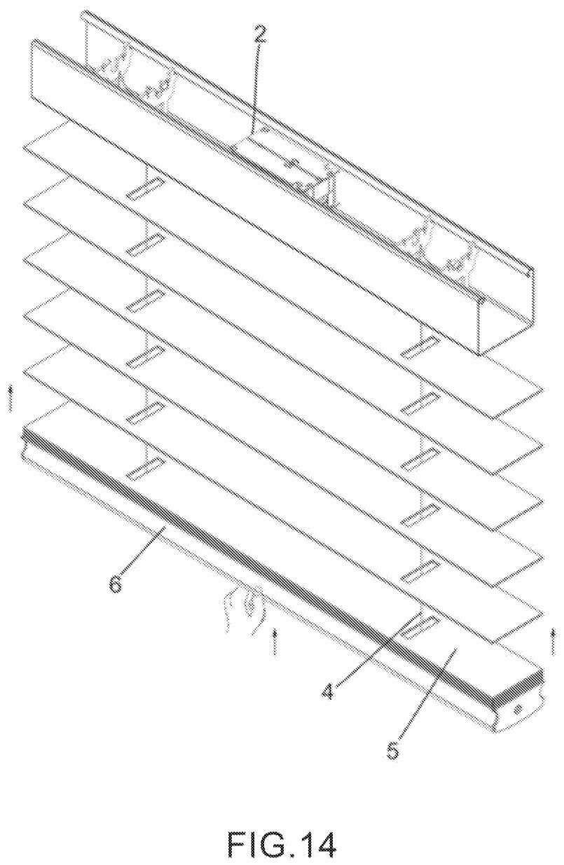

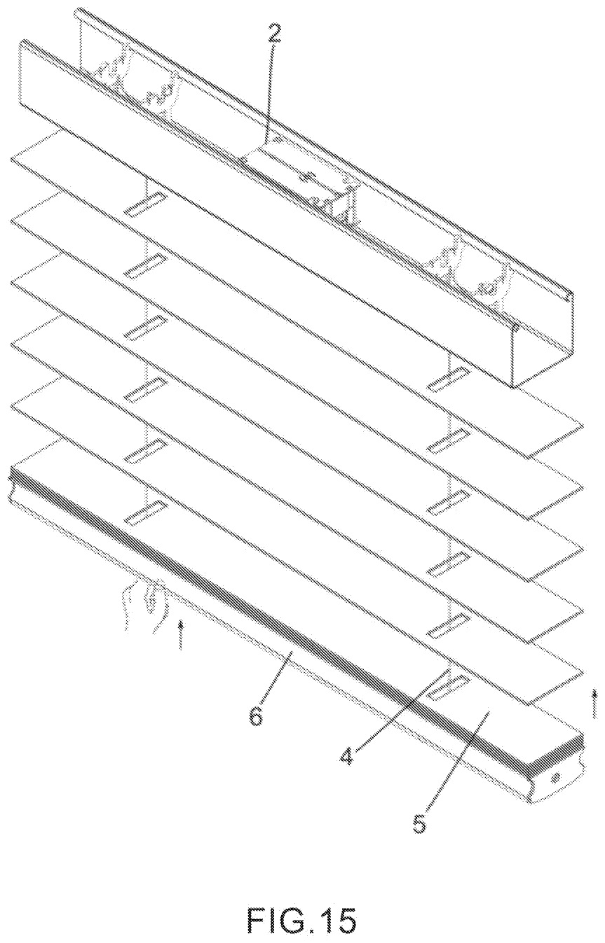

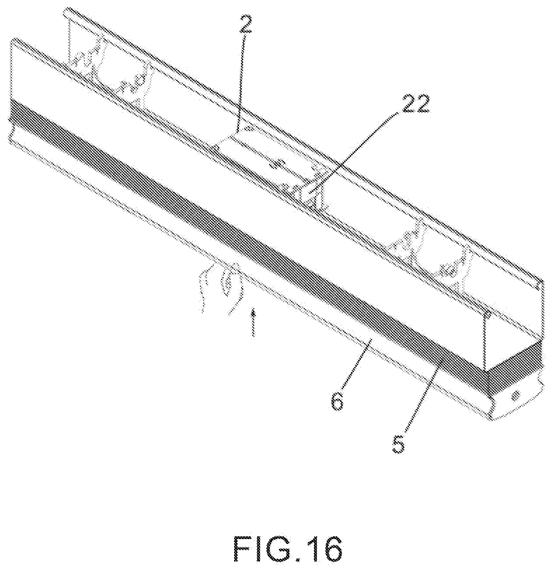

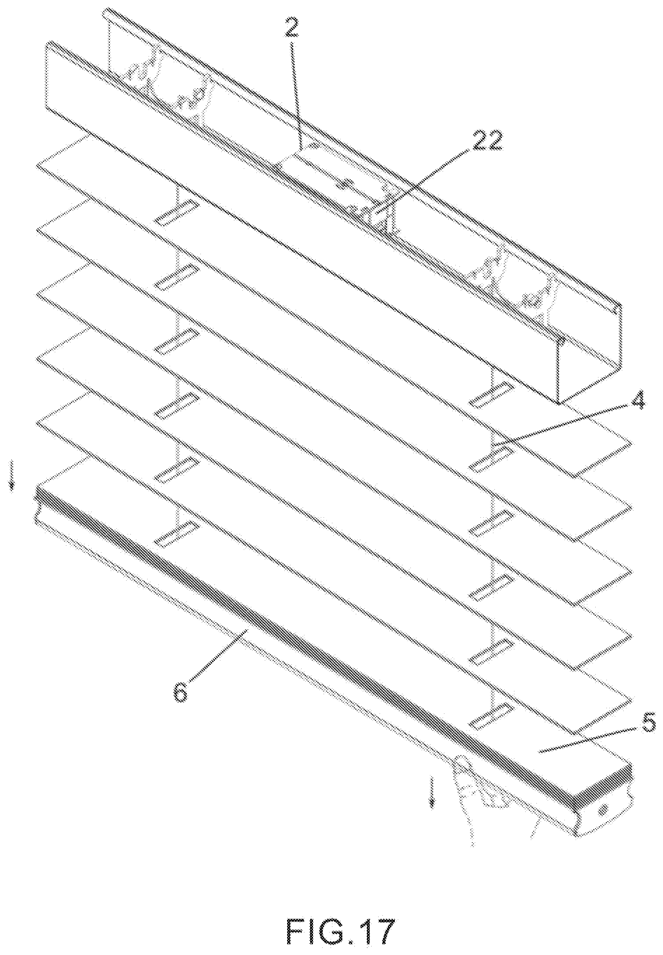

With respect to the synchronized balancing concept of the present invention (as shown in FIGS. 11 and 12), the two lift cords 4 are connected with the cord reel 22 in the spring box 2. The cord reel 22 provides a rotational elastic force to generate synchronization tension support and the bottom rail 6 and the slats 5 provide weight support. By means of the synchronization of the friction balance point brass roller 3A, the bottom rail 6 and the slats 5 are always kept in synchronization balancing position and balancing weight. Therefore, when it is desired to spread the slats 5 downward, a user can pull any portion of the bottom rail 6 with a hand to synchronously spread the slats 5 downward. At this time, the lift cord 4 will move forward (as shown in FIG. 13). In addition, the tension of the cord reel 22 and the weight of the bottom rail 6 and the synchronization of the friction balance point brass roller 3A are always kept equal to each other. Therefore, the bottom rail 6 can be pulled to any position and located therein. When it is desired to move the bottom rail 6 upward to collect the slats 5, the user can touch and lift any portion of the lower side of the bottom rail 6 with a hand, for example, a middle portion or a lateral portion of the lower side of the bottom rail 6 (as shown in FIGS. 14 and 15) to evenly move the bottom rail 6 upward and collect the slats 5. All this time, the lift cord 4 is moved outward and prevented from slipping into the gap (with reference to FIG. 13 again). The balancing weight and the balancing position between the weight of the bottom rail 6 and the slats 5 and the tension of the cord reel 22 connected with the lift cord 4 are changed. Therefore, at this time, the cord reel 22 in the spring box 2 with elastic force is rotated to synchronously drive the two lift cords 4 to lift the bottom rail 6. When the hand stops lifting the bottom rail 6 or pulls the bottom rail 6 to any position, the balancing weight and balancing position and tension balancing state are restored to locate the slats 5 and the bottom Rail 6 (as shown in FIGS. 16 and 17).

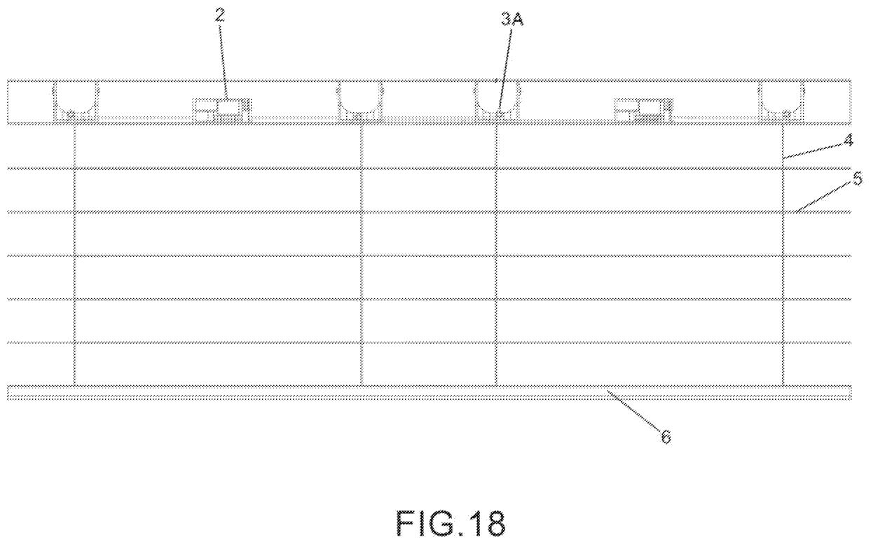

FIG. 18 shows an embodiment of the present invention, in which four friction balancing point brass rollers 3A are installed. In this embodiment, four lift cords 4 are conducted through four friction balance point brass rollers 3A to connect with two spring boxes 2 for synchronously controlling the bottom rail 6 and the slats 5 to upward collect the slats 5 or downward spread the slats 5. In this embodiment, the cord reel 22 in the spring box 2 also provides a rotational elastic force to generate a tension support. By means of the synchronization friction of the friction balance point brass rollers 3A, the tension support and the weight support of the bottom rail 6 and the slats 5 are always kept in synchronized balancing position and balancing weight and tension balancing. Therefore, a user's hand can pull or touch and lift any portion of lower side of the bottom rail 6 with a hand to control the bottom rail 6 and the slats 5 to synchronously spread the slats 5 downward or collect the slats 5 upward and achieve a locating effect.

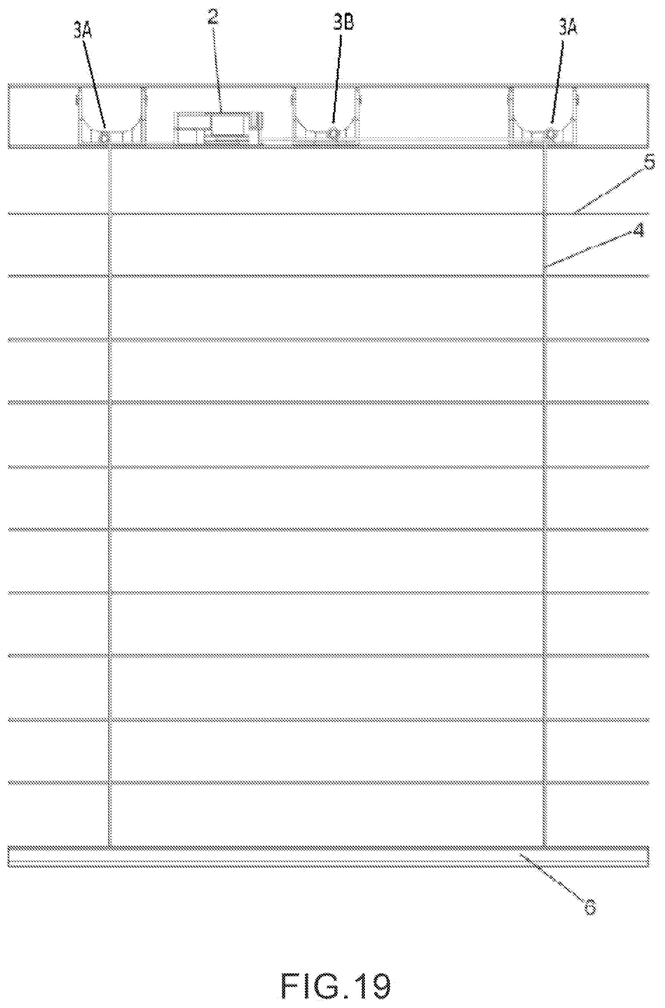

FIG. 19 shows an embodiment of the present invention, in which three friction balancing point brass rollers are installed, 3A in two tape drum supports and a 3B in one tape drum support. In this embodiment, two lift cords 4 are conducted through three friction balance point brass rollers 3A and 3B to connect with one spring box 2 for synchronously controlling the bottom rail 6 and the slats 5 to upward collect the slats 5 or downward spread the slats 5. In this embodiment, the cord reel 22 in the spring box 2 also provides a rotational elastic force to generate a tension support. By means of the synchronization of the two-friction balance point brass rollers 3A and the single ladder only tape drum support with a friction balance point brass roller 3B, the tension support and the weight support of the bottom rail 6 and the slats 5 are always kept in synchronized balancing position and balancing weight and tension balancing. Therefore, a user's hand can pull or touch and lift any portion of lower side of the bottom rail 6 with a hand to control the bottom rail 6 and the slats 5 to synchronously spread the slats 5 downward or collect the slats 5 upward and achieve a locating effect.

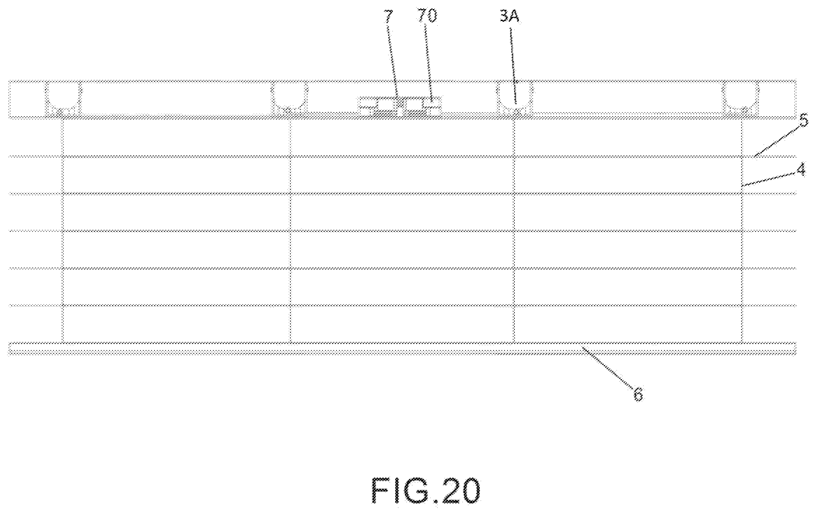

FIG. 20 shows an embodiment of the present invention, in which four lift cords 4 are installed. In this embodiment, four lift cords 4 are conducted through four friction balance point brass rollers 3A to connect with a spring box 7 with an even-number cord reels and even-number springs for synchronously controlling the bottom rail 6 and the slats 5 to upward collect the slats 5 or downward spread the slats 5. In this embodiment, the even-number cord reels 70 in the spring box 7 also provides a rotational elastic force to generate a tension support. By means of the synchronization of the friction balance point brass rollers 3A, the tension support and the weight support of the bottom rail 6 and the slats 5 are always kept in synchronized balancing position and balancing weight and tension balancing. Therefore, a user's hand can pull or touch and lift any portion of lower side of the bottom rail 6 with a hand to control the bottom rail 6 and the slats 5 to synchronously spread the slats 5 downward or collect the slats 5 upward and achieve a locating effect.

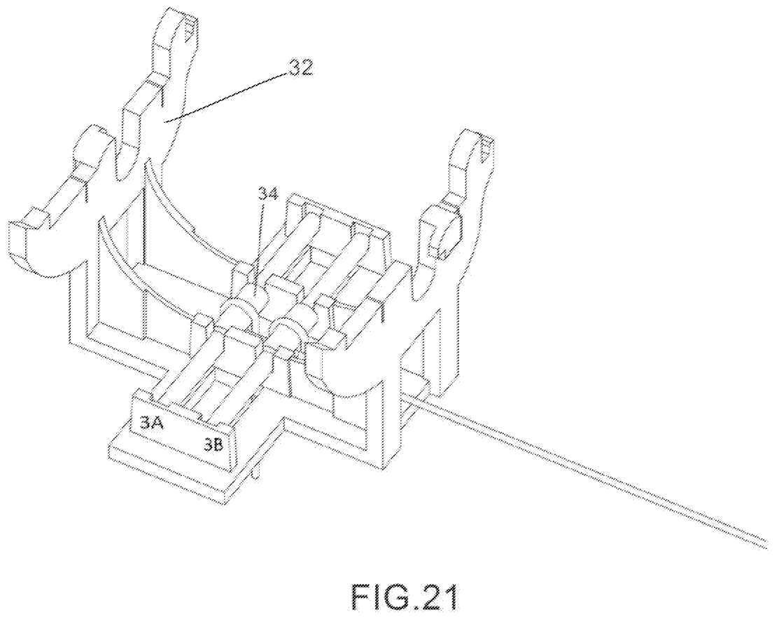

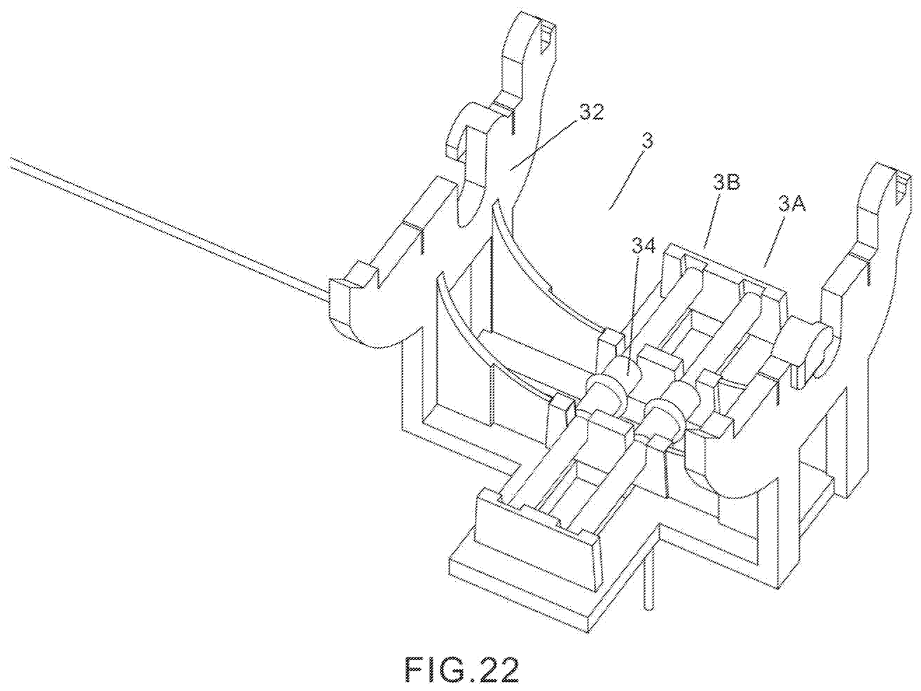

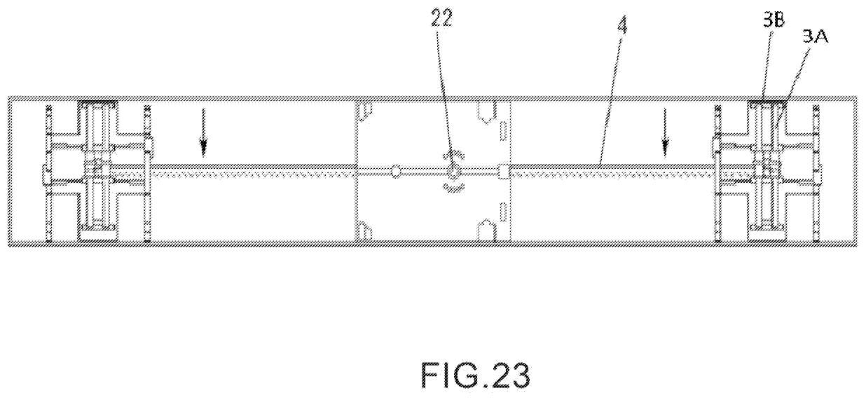

Please refer to FIGS. 21 to 23. In case the tension of the cord reel 22 fails to match the weight of the bottom rail 6 and the slats 5 and cannot be balanced therewith so as to move the bottom rail 6 and the slats 5 up or down to reach a desired position, the number of friction balance brass rollers 3 per tape drum support 32 is increased to one 3A and one 3B for increased friction or at least one weight rod is placed into the bottom rail 6 so as to enhance the synchronization of the balance point brass rollers 3A. Therefore, the tension of the cord reel 22 can match the weight of the bottom rail 6 to achieve a stable balanced state.

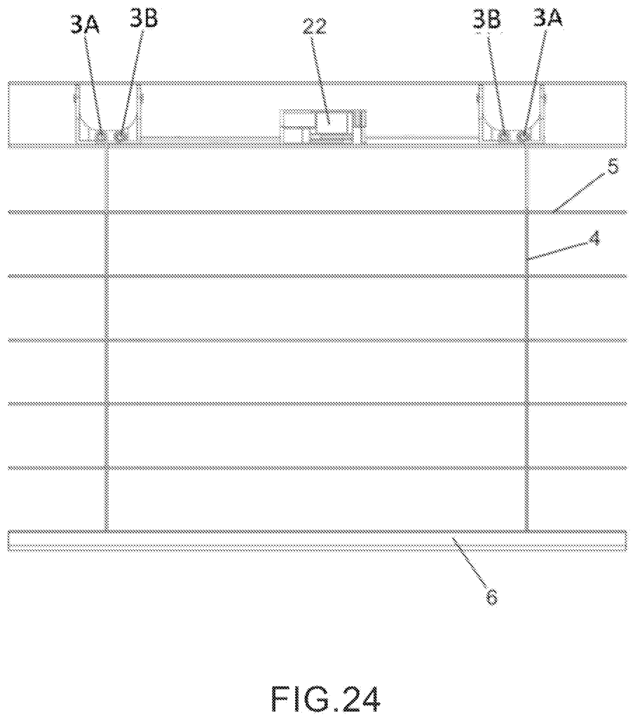

Please now refer to FIG. 24. In case there are less slats and the weight is lighter and the tension of the cord reel 22 is greater than the weight of the bottom rail 6 and the slats 5 in an unbalanced state, a second friction balance point brass roller 3B is added to the 3A in the tape drum supports 32 so the increased friction will enhance the synchronization of the balance point brass rollers 3, whereby the tension of the cord reel 22 can match the weight of the bottom rail 6 to achieve a stable balanced state.

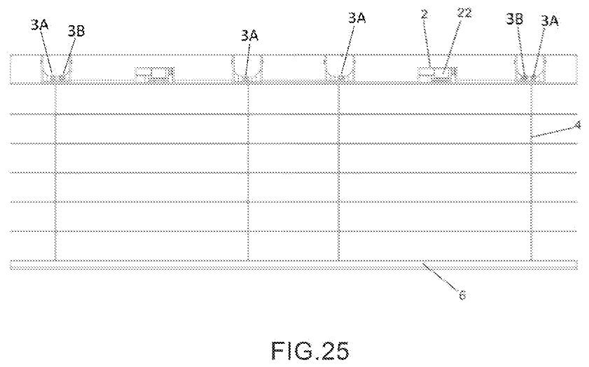

Please now refer to FIG. 25, which shows the mixed installation with even-number of the friction balance point brass rollers 3A and 3B in the outer tape drum supports. In this embodiment, the number of friction balance point brass rollers 3A is increased with 3B in the outer tape drum supports so as to enhance the friction synchronization of the friction balance point brass rollers 3A. Four balance point brass rollers 3A, two additional friction balance brass rollers 3B, four lift cords 4 and two spring boxes 2 are assembled with each other, whereby the tension of the cord reel 22 can match the weight of the bottom rail 6 to achieve a stable balanced state.

The above embodiments are only used to illustrate the present invention, not intended to limit the scope thereof. Many modifications of the above embodiments can be made without departing from the spirit of the present invention.

What is claimed is:

1. A horizontal synchronized balancing system comprising:
a rail having an inward recessed space;
at least two friction balance point brass rollers, each of the friction balance point brass rollers including at least one steel rod and at least one brass roller fitted on the steel rod and a tape drum support having two recesses, the tape drum support being secured in the two sides of the rail, the friction balance point brass drum's steel rod being secured in the recesses of the tape drum support without possibility of rotation;
at least two lift cords, a head in of each lift cord being connected on the cord reel of the spring box, while a tail end of the lift cord being conducted through a lower side of the friction balance point brass roller and the wound up and over the friction balance point brass roller and then downward conducted through the hole at the middle of the tape drum support and conducted through a slot of each slat to connect with a bottom rail, by means of the tension support of the cord reel in the spring box and the weight support of the bottom rail and the slats and the synchronization provided by the friction balance point brass rollers, the bottom rail and the slats being always kept in the balancing position and balancing weight, also, at least two lift cords having balancing synchronization tension, whereby in case the tension of the cord reel fails to match the weight of the bottom rail and the slats and cannot be balanced therewith so as to move the bottom rail and the slats up or down to reach a desired position. The number of the friction balance point brass rollers is increased or at least one weight rod is placed into the bottom rail so as to enhance the synchronization of the balance point brass rollers so that the tension of the cord reel can match the weight of the bottom rail to achieve a stable balanced state, whereby a user can pull or touch and lift any portion of the bottom rail with a hand to spread the slats downward or collect the slats upward and achieve a locating effect, in addition, by means of rotating the brass roller of the friction balance point brass rollers, the ascending and descending operation of the slats and the bottom rail are performed with less strength.

2. The horizontal synchronization balancing system as claimed in claim 1, wherein an outer circumferential surface of the brass roller is a polished face, whereby the frictional force between the lift cord and the brass roller is reduced so as to prolong the lifetime of the lift cord.

3. The horizontal synchronization balancing system as claimed in claim 1, wherein a gap is defined between the brass roller and the steel rod fitted in the brass roller, whereby the steel rod only contacts the brass roller by a line so the brass roller is easily rotatable to save strength.

4. The horizontal synchronization balancing system as claimed in claim 1, wherein the tension applied to the lift cord connected with the cord reel is greater than the weight of the bottom rail and the slats.
